(19) United States
(12) Patent Application Publication
(10) Pub. No.: US 2004/0177277 A1
(43) Pub. Date: Sep. 9, 2004

(54) Apparatus and method for blocking harmful internet site

(75) Inventors: Ku Hyeon Ryu, Daejeon-si (KR); Kyoung Sun Min, Daejeon-si (KR); Byoung Hee Lee, Daejeon-si (KR)

Correspondence Address: MERCHANT & GOULD PC, P.O. BOX 2903, MINNEAPOLIS, MN, 55402-0903, US

(73) Assignee: KT CORPORATION, KYOUNGGI-DO (KR)

(21) Appl. No.: 10/746,193

(22) Filed: Dec. 22, 2003

Related U.S. Application Data
(60) Provisional application No. 60/436,221, filed on Dec. 24, 2002.

(51) Int. Cl. H04L 9/00

(52) U.S. Cl. 713/201

(57) ABSTRACT

Disclosed are an apparatus and a method for blocking internet harmful sites. The apparatus comprises an NAS for receiving a connection signal from a DSLAM if internet service subscribers try connection and for assigning a PPP and an IP to a subscriber terminal; a certification server; a switching unit for certifying a harmful site blocking service subscriber of the subscribers and for assigning the PPP and the IP to the harmful site blocking service subscriber; and a blocking server for preventing a subscriber connected to the switching unit from connecting to a harmful site, wherein the NAS assigns the PPP and the IP into a subscriber terminal if the subscriber is a general internet service subscriber as a certification result of the certification server, and the certification server transmits an IP address and subscriber information on the switching unit into the NAS if the subscriber is a harmful site blocking service subscriber as a certification result of the certification server, and the NAS constitutes a L2TP tunnel toward the switching unit to transmit the subscriber information.

### BACKGROUND OF THE INVENTION

1. Field of the Invention

The present invention generally relates to an apparatus and a method for blocking a harmful internet site. More specifically, the present invention relates to an apparatus and a method for blocking a harmful internet site by using a L2TP (Layer 2 Tunneling Protocol) function. The L2TP function is embodied by classification of service usage conditions of internet service subscribers.

2. Description of the Prior Art

Recently, various services have been provided on the Internet due to rapid expansion of the Internet.

Since most of these internet services are open, anyone can use the internet services easily.

Although there are sites for providing useful information in the Internet service, there are also harmful sites such as pornography sites and suicide inciting sites which stimulate the psychology of juveniles and confuse their values.

This harmful web site which is one of ill effects resulting from the development of the Internet has a demoralizing influence upon the minds of the youth.

According to a conventional method for blocking harmful sites, harmful site blocking service has been wholly provided to subscribers connected to a Network Access Server (hereinafter, abbreviated as “NAS”) which provides the subscribers an Asynchronous Transfer Mode (hereinafter, abbreviated as “ATM”) disconnection function.

However, the above conventional method requires an additional NAS for harmful site blocking service, and disables the subscribers from using general internet service and harmful site blocking service with one internet line simultaneously.

### SUMMARY OF THE INVENTION

Accordingly, it is an object of the present invention to block harmful sites in all internet lines without an additional apparatus for harmful site blocking service.

In an embodiment, an apparatus for blocking internet harmful sites comprises an NAS (Network Access Server), a certification server, a switching unit and a blocking server. The NAS receives a connection signal from a DSLAM (Digital Subscriber Line Access Multiplexer) if internet service subscribers try connection, and assigns a PPP (Point-to-Point Protocol) and an IP (Internet Protocol) to a subscriber terminal. The certification server certifies the subscribers. The switching unit certifies a harmful site blocking service subscriber of the subscribers, and assigns the PPP and the IP to the harmful site blocking service subscriber. The blocking server, which contains a list on harmful sites, prevents a subscriber connected to the switching unit from connecting to a harmful site. Here, the NAS assigns the PPP and the IP into a subscriber terminal if the subscriber is a general internet service subscriber as a certification result of the certification server, and the certification server transmits an IP address and subscriber information on the switching unit into the NAS if the subscriber is a harmful site blocking service subscriber as a certification result of the certification server, and the NAS constitutes a L2TP tunnel toward the switching unit to transmit the subscriber information.

In an embodiment, a method for blocking a harmful internet site comprises:

a first process wherein the certification server certifies a subscriber if an internet service subscriber connects to the NAS;

a second process for transmitting the IP address and subscriber information on the switching unit into the NAS if the subscriber is a harmful site blocking service subscriber as the certification result of the certification server;

a third process wherein the NAS constitutes a L2TP tunnel toward the switching unit depending on the information and transmits the harmful site blocking service subscriber information using the L2TP tunnel, and the switching unit performs a subscriber certification;

a fourth process wherein the switching unit assigns the PPP and the IP to the harmful site blocking service subscriber terminal when the subscriber is a legitimate subscriber as the certification result of the switching unit; and

a fifth process wherein the blocking server supervises an internet traffic of the harmful site blocking service subscriber through the switching unit, and blocks traffic transmission of a subscriber who connects to a harmful site.

### BRIEF DESCRIPTION OF THE DRAWINGS

FIG. 1 is a block diagram illustrating an apparatus for blocking a harmful internet site according to an embodiment of the present invention.

FIG. 2 is a flow chart illustrating conventional internet service.

FIG. 3 is a flow chart illustrating harmful site blocking service according to an embodiment of the present invention.

### DETAILED DESCRIPTION OF THE PREFERRED EMBODIMENTS

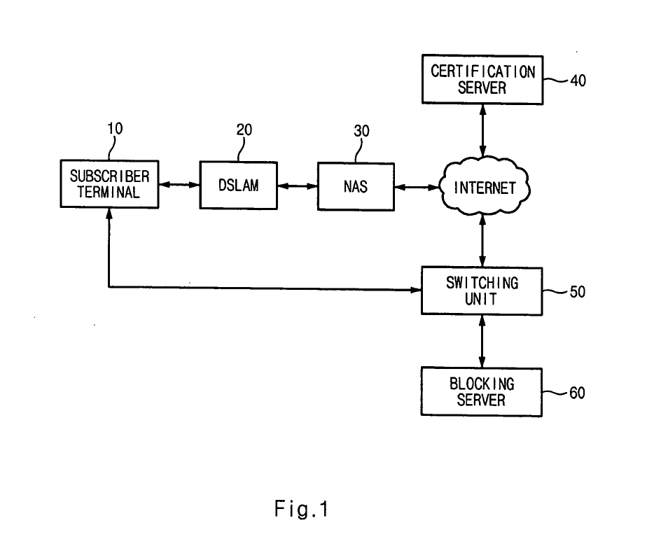

FIG. 1 is a block diagram illustrating an apparatus for blocking a harmful internet site according to an embodiment of the present invention. In an embodiment, the apparatus for blocking a harmful internet site comprises a subscriber terminal 10, a Digital Subscriber Line Access Multiplexer (hereinafter, abbreviated as “DSLAM”) 20, a Network Access Server (hereinafter, abbreviated as “NAS”) 30, a certification server 40, a switching unit 50 and a blocking server 60. The subscriber terminal 10 receives internet service. The DSLAM 20 receives a connection signal of the subscriber terminal 10, and transmits the connection signal into a high-speed backbone with a multiplexing technology. The NAS 30 which receives a signal from the DSLAM 20 connects a subscriber to the Internet and administrates traffic. The certification server 40 certifies the subscribers, and assorts a harmful site blocking service subscriber. The switching unit 50 certifies a harmful site blocking service subscriber, connects the certified harmful site blocking service subscriber to the Internet, and administrates traffic. The blocking server 60 which contains a list on harmful sites prevents the subscriber connected to the switching unit 50 from connecting to a harmful site.

The certification server 40 which performs a certification process on subscribers provides internet service using the NAS 30 for the subscribers.

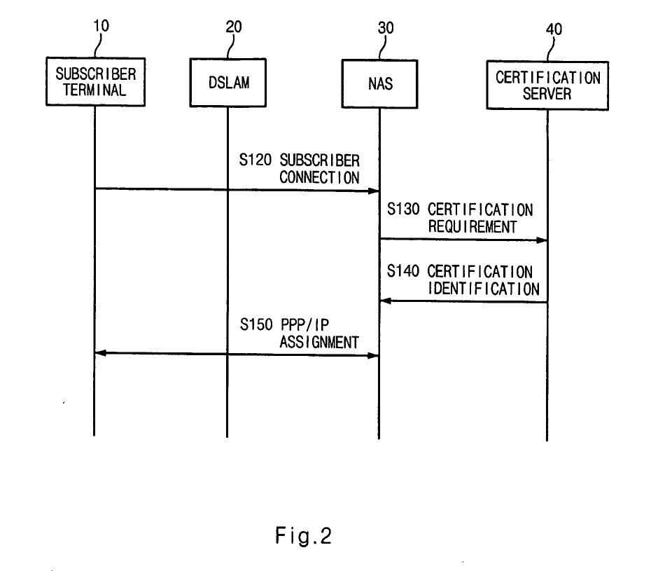

As shown in FIG. 2, a general internet service subscriber tries internet connection through the subscriber terminal 10 and then connects to the NAS 30 through the DSLAM 20 (S120). Then, the NAS 30 transmits subscriber information into the certification server 40 for subscriber certification to perform the certification process on connection (S130). If the NAS 30 receives certification of the certification server 40 (S140), the NAS 30 assigns a Point-to-Point Protocol (hereinafter, abbreviated as “PPP”) and an Internet Protocol (hereinafter, abbreviated as “IP”), thereby connecting the subscriber to the internet (S150).

However, a harmful site blocking service subscriber is enabled to use a specific domain which can be separated in the certification server 40.

For example, a subscriber is made to use user@children. If the subscriber who has such domain connects to a web site, the certification server 40 analyzes the domain to determine that the subscriber is a harmful site blocking service subscriber by @children. Then, the certification server 40 transmits an IP address and related information on the switching unit 50 for performing an actual administration on harmful site blocking service subscribers into the NAS 30.

The NAS 30 forms a L2TP tunnel with the switching unit 50 using the above information, and transmits an ID (user) and a password of the subscriber.

The L2TP function enables business personnel who moves and works or common people who performs an operation related to business work at home to connect to a business server with security on the network.

In this case, the switching unit 50 performs a LNS (L2TP Network Server) function of the L2TP, and the NAS 30 performs a LAC (L2TP Access Concentrator) function of the L2TP.

That is, if a virtual interface for the PPP is generated in the switching unit 50, the NAS 30 completes the PPP through the virtual interface.

The switching unit 50 that receives subscriber information in the above-described way certifies the subscriber. If the subscriber is a legitimate subscriber who is registered in the harmful site blocking service, the NAS 30 directly assigns the PPP and the IP to the subscriber terminal 10, and directly administrates traffic of the subscriber. The switching unit 50 having these functions may be a router or a switch.

Here, the NAS 30 which serves as the LAC function connects connection traffic of the subscriber to the switching unit 50, and does not perform an IP routing function to the subscriber terminal 10 directly.

The internet traffic transmitted from the subscriber terminal 10 to the switching unit 50 is continuously supervised by the blocking server 60 which contains a harmful site blocking list. If the subscriber traffic is connected to a harmful site, the blocking server 60 enables the switching unit 50 to disconnect site connection of a corresponding subscriber.

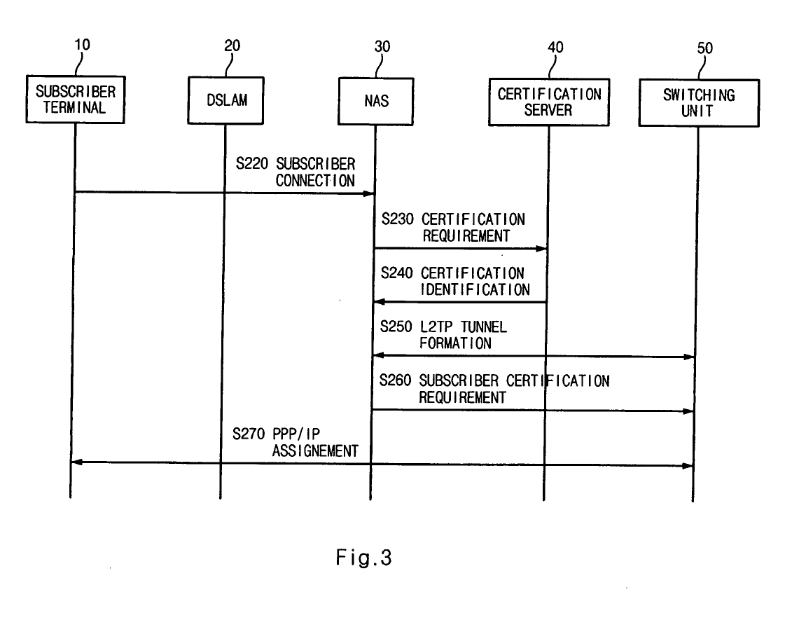

FIG. 3 is a flow chart illustrating a method for blocking a harmful internet site according to an embodiment of the present invention.

If a subscriber tries connecting to the Internet to connect to the NAS 30 through the DSLAM 20 (S220), the NAS 30 requires subscriber certification to the certification server 40 (S230).

If the certification server 40 performs a certification process to determine that the subscriber is a harmful site blocking service subscriber, the subscriber transmits related information into the NAS 30 because the subscriber should receive certification in the switching unit 50 for performing an actual administration on the harmful site blocking service subscriber.

Then, the NAS 30 forms a L2TP tunnel toward the switching unit 50 (S250), and transmits subscriber information using the L2TP tunnel to require subscriber certification (S260).

The switching unit 50 performs the certification process on the required subscriber, and directly assigns the PPP and the IP to the subscriber terminal 10 if the subscriber is a legitimate subscriber as a certification result (S270).

The internet traffic of the harmful site blocking service subscriber is separated from the NAS 30 and transmitted into the switching unit 50. As a result, the switching unit 50 directly administrates and controls the traffic.

The switching unit 50 analyzes traffic of subscribers who require connection to harmful sites by the blocking server 60, and prevents subscribers who try to connect to harmful sites traffic transmission on the Internet from transmitting traffic on the Internet. Then, the switching unit 50 reports the subscribers that they cannot connect to the currently required site.

As discussed earlier, in an apparatus and a method for blocking a harmful site according to an embodiment of the present invention, both of general internet service and harmful site blocking service are provided on the same internet line with different Ids and passwords.

Also, harmful sites may be blocked with various harmful site blocking programs which are administrated by class or by item.

Additionally, since blocking service having different types is provided through connection to a different blocking system with different connection IDs, various services that satisfy requirements of subscribers can be provided.

What is claimed is:

1. An apparatus for blocking internet harmful sites, comprising:
an NAS (Network Access Server) for receiving a connection signal from a DSLAM (Digital Subscriber Line Access Multiplexer) if internet service subscribers try connection, and for assigning a PPP (Point-to-Point Protocol) and an IP (Internet Protocol) to a subscriber terminal;
a certification server for certifying the subscribers;
a switching unit for certifying a harmful site blocking service subscriber of the subscribers and for assigning the PPP and the IP to the harmful site blocking service subscriber; and
a blocking server, containing a list on harmful sites, for preventing a subscriber connected to the switching unit from connecting to a harmful site,
wherein the NAS assigns the PPP and the IP into a subscriber terminal if the subscriber is a general internet service subscriber as a certification result of the certification server, and the certification server transmits an IP address and subscriber information on the switching unit into the NAS if the subscriber is a harmful site blocking service subscriber as a certification result of the certification server, and
the NAS constitutes a L2TP tunnel toward the switching unit to transmit the subscriber information.

2. The apparatus according to claim 1, wherein the harmful site blocking service subscriber enables the certification server to determine that the subscriber is a harmful site blocking service subscriber with an additional specific domain.

3. The apparatus according to claim 1, wherein the switching unit is a router.

4. The apparatus according to claim 1, wherein the switching unit is a switch.

5. A method for blocking a harmful internet site by using a system comprising an NAS for administering traffic of internet service subscribers transmitted from a DSLAM; a certification server for certifying the subscribers; a switching unit for certifying a harmful site blocking service subscriber of the subscribers and for administering traffic of the harmful site blocking service subscriber; a blocking server, containing a list on harmful sites, for preventing a subscriber connected to the switching unit from connecting to a harmful site, the method comprising:
a first process wherein the certification server certifies a subscriber if an internet service subscriber connects to the NAS;
a second process for transmitting the IP address and subscriber information on the switching unit into the NAS if the subscriber is a harmful site blocking service subscriber as the certification result of the certification server;
a third process wherein the NAS constitutes a L2TP tunnel toward the switching unit depending on the information and transmits the harmful site blocking service subscriber information using the L2TP tunnel, and the switching unit performs a subscriber certification;
a fourth process wherein the switching unit assigns the PPP and the IP to the harmful site blocking service subscriber terminal when the subscriber is a legitimate subscriber as the certification result of the switching unit; and
a fifth process wherein the blocking server supervises an internet traffic of the harmful site blocking service subscriber through the switching unit, and blocks traffic transmission of a subscriber who connects to a harmful site.

6. The method according to claim 5, wherein the harmful site blocking service subscriber information enables the certification server to determine that the subscriber is the harmful site blocking service subscriber with an additional specific domain.
